(19) United States
(12) Patent Application Publication
(10) Pub. No.: US 2008/0210673 A1
(43) Pub. Date: Sep. 4, 2008

(54) Femtosecond Laser Micromachining Device with Dynamic Bean Conformation

(75) Inventors: Eric Audouard, Solignac-sous-Roche (FR); Nicolas Huot, Saint Genest Malifaux (FR); Herve Soder, Saint Etienne (FR)

Correspondence Address: HESLIN ROTHENBERG FARLEY & MESITI PC, 5 COLUMBIA CIRCLE, ALBANY, NY, 12203, US

(73) Assignees: IMPULSION, Saint Etienne (FR); UNIVERSITE JEAN MONNET, Saint Etienne Cedex 2 (FR); CENTRE NATIONAL DE LA RECHERCHE SCIENTIFIQUE, Paris (FR)

(21) Appl. No.: 11/911,985

(22) PCT Filed: Apr. 19, 2006
(86) PCT No.: PCT/FR2006/050356

§ 371 Date: Dec. 10, 2007

(30) Foreign Application Priority Data
Apr. 20, 2005 (FR) 0551007

(51) Int. Cl. B23K 26/04

(52) U.S. Cl. 219/121.81

(57) ABSTRACT

The device comprises a laser-type coherent light radiation source transmitting ultrashort pulses, a dynamic beam shaping arrangement and an arrangement for using and processing a laser beam. The dynamic beam shaping arrangement comprises an optical system including a part for actively modifying the laser beam wavefront and a detecting part, excepting a phase meter, used for three-dimensionally shaping the beam. These parts are connected by a feed-back circuit and the active modifying part comprises a first fixed or active component and a second active component.

The invention relates to the technical field of micromachining of various materials, in particular by femtosecond laser.

It has already been proposed to carry out micromachining operations by using laser sources producing ultrashort pulses. Mention can be made, for example, of the teaching of patent U.S. Pat. No. 6,285,002 and the teaching of patent EP 1.011.911 which relates to the ultrashort pulse laser machining of metals and alloys.

Reference can be made to the publications [Momma 1996]: C. Momma, B. N. Chichkov, S. Nolte, F. Von Alvensleben, A. Tunnermann, H. Welling and B. Wellegehausen, Opt. Comm. 129, 134 (1996) and [Le Harzic 2002]: R, Le Harzic, N. Huot, R. Audouard, C. Jonin, P. Laporte, S. Valette, A. Fraczkievicz and R. Fortunier, Appl. Phys. Lett. 80, 3886 (2002), which show that ultrashort pulse laser methods have a particularly advantageous application for micromachinings with extremely limited collateral thermal effect for sufficiently thin materials, particularly thinner than one millimetre.

Furthermore, it appears from the publication [Cordingley 1993] J. Cordingley, Appl. Opt. 32, 2538 (1993) that the laser methods using fixed diffracting optical elements allow beam formatting before the process. Ultrashort laser methods are also known using a dynamic wavefront correction with feedback by phase measurement [Sanner 2004] N. Sanner, N. Huot, E. Audouard, C. Larat, P. Laporte and J. P. Huignard. The technical results obtained can be considered satisfactory, while however observing that the use of a wavefront sensor (phase meter) is prohibitively costly.

It is the object of the invention to remedy these drawbacks simply, safely, effectively and efficiently.

The problem that the invention proposes to solve is to eliminate the wavefront sensor which serves to obtain a linear correction with a virtually direct correspondence between addressing pixels and detected pixels and to use an optimisation method according to the invention to make the correction.

A femtosecond laser micromachining device has therefore been designed and developed with dynamic beam conformation of the type of those comprising:

a coherent light radiation source of the laser type emitting ultrashort pulses;

a dynamic beam conformation assembly;

a laser ray application and processing assembly.

According to the invention, in view of the problem raised, to provide the dynamic compression of the beam without phase measurement, the dynamic beam conformation assembly comprises an optical system comprising an active part for modifying the wavefront of the laser source and detection means, to the exclusion of a phase meter unit, suitable for spatially formatting the beam, the said parts being connected by a negative feedback loop, the active modification part containing a first fixed or active component and a second active component.

Due to the problem raised of avoiding the use of a wavefront sensor, the means for the spatial formatting of the beam is a simple detection system of the CDD camera or photodetector type.

To solve the problem of obtaining computer convergence, the negative feedback loop applies an algorithm selected to adapt the phase functions obtained by the first and second components, in order to optimise the result in the form of a note attributed by criteria depending on the simple detection system selected.

According to one basic feature of the invention, the action of a high speed ultrashort pulse laser, with programmable beam formatting, without phase measurement, offers a real industrial advantage. In particular, it appears that the high speed decreases the process ratio, while the programmable formatting serves to structure the beam shape and vary it by computer. Particularly importantly, the absence of a phase measurement economizes the use of a wavefront sensor or an interferometric device, which are prohibitively expensive.

The invention is described in greater detail below in conjunction with the figures of the drawings appended hereto in which:

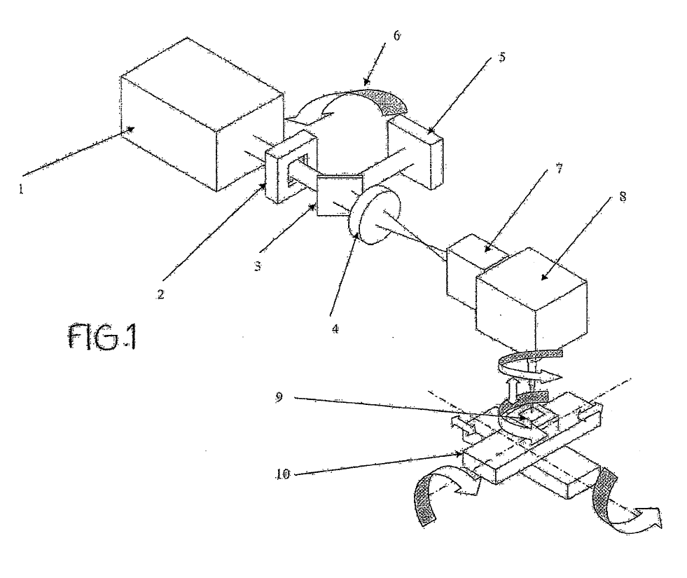

FIG. 1 is a purely schematic view of the main units of the device of the invention for implementing the laser method as part of micromachining operations, in the case of a direct transmission of the laser source;

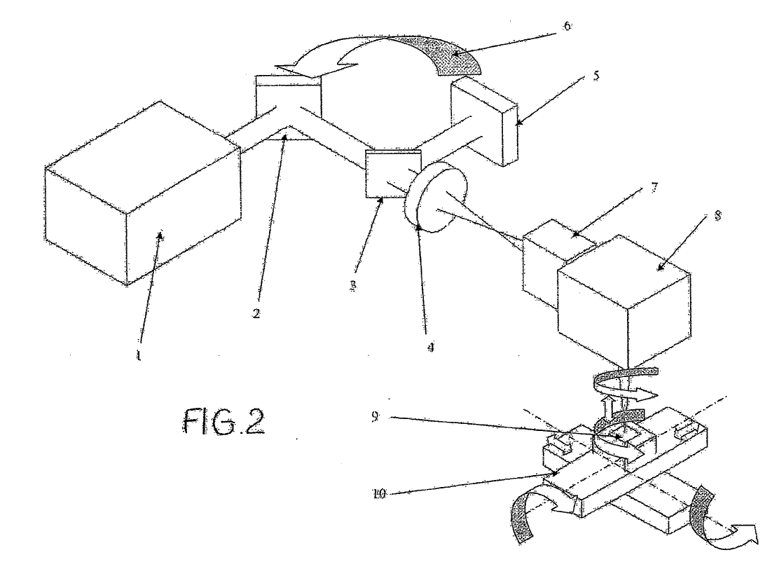

FIG. 2 is a similar view to FIG. 1, in the case of transmission by reflection of the laser source.

The femtosecond laser micromachining device comprises, in combination with a coherent light radiation source of the laser type emitting ultrashort pulses (1), a dynamic beam conformation assembly (2), (3), (4), (5) and (6) and a laser ray application and processing assembly (7), (8), (9) and (10) (micromachining operation, for example).

The laser source (1) functions in mode blockage pulse regime and delivers ultrashort pulses with a duration shorter than 100 ps and at repetition speeds equal to or greater than 1 kHz. The energies delivered for each pulse are generally higher than or equal to 1 nJ. The laser source emits at a wavelength compatible with the dynamic beam conformation assembly. By way of a non-limiting example, a source may consist of an amplified femtosecond circuit based on a titanium-doped sapphire crystal emitting pulses of 4 μJ for a duration of 200 fs at a speed varying from 10 to 250 kHz.

Without going beyond the scope of the invention, other solutions can be considered. For example, a femtosecond source can be used pumped by diodes and based on the doping of the ytterbium ion emitting pulses of 100 μJ for a duration of 400 fs at a speed of 1 to 10 kHz. It is also possible to use an amplified femtosecond source based on the titanium-doped sapphire crystal emitting pulses of about 1-1.5 mJ for a duration of 150 fs at a speed of 1-5 kHz.

The dynamic beam conformation assembly comprises an optical device comprising a system for active modification of the wavefront (2) of the laser source (1) and a detection system without phase measurement (5). The wavefront modification system (2) and the detection system without phase measurement (5) are connected by a negative feedback loop (6).

Importantly, and according to a basic feature of the invention and as shall be described in the rest of the description, the detection system (5) is not a wavefront sensor whatsoever or a phase measurement interferometric device.

The active wavefront modification system (5) contains a first fixed or active component and a second active component.

The first component has a low spatial resolution in terms of wavefront sculpture.

While this component is fixed, it may consist of an afocal optical system comprising lenses or mirrors and which is suitable for providing a wavefront curvature. This first component, when fixed, may also consist of a diffracting optical element performing a “preformatting” for function modulated by the second component.

When this first component is active, it may consist of a deformable mirror (for example of the type of those marketed by CILAS France) or a deformable membrane (for example of the type of those marketed at OKO Technologies, Japan) or an optically addressed optical valve and more generally by any means for obtaining a spatial phase modulation with a fairly high dynamic (typically equal to or greater than 2π) with a low spatial resolution, particularly with pixels not exceeding 100 μm.

These various components are electrically or optically addressed and controlled by computer. They can operate by reflection or transmission.

When the first component is active, it serves to obtain the phase function necessary for obtaining the desired formatting, without necessarily resolving the details of this basic function. In this case, such details are provided by the second active component.

This second component has a high spatial resolution with a pixel size equal to or smaller than 100 μm and a number of pixels of at least 100. This second active component is based on a liquid crystal layer and may, for example, consist of a spatial light modulator set as a phase modulator and addressed electrically, or may consist of an optical valve optically addressed and more generally, any means performing this function with a sufficient spatial resolution. This active component may operate by reflection or by transmission, while having the function of enhancing the spatial form of the wavefront.

According to one important feature of the invention, the detection system (5), combined with the negative feedback loop (6) serves to attribute a note to the formatting obtained. Fundamentally, the detection system is not a phase measurement device for comparing the wavefront obtained with an expected phase front. It is a simple detection system of the CDD camera or photo detector type, after non-linear crystal.

More generally, according to the invention, the system without wavefront sensor may consist of any detection system having the function of spatially formatting the beam and serving to obtain a better result. In the context of the present invention, result means a note attributed according to the criteria depending on the means selected, for example, image quality if with a CDD camera or frequency doubled intensity detected on a photodiode.

With this technical solution, the note attributed depends also on the ratio of addressing pixels. This means that there is no longer a direct correspondence as is the case with a wavefront sensor. It is therefore necessary to optimise the addressing matrix assembly at the same time. The note is integrated in the negative feedback loop (6).

In view of these features, to obtain the computer convergence, the negative feedback loop uses an algorithm for adapting the phase functions obtained by the first and second components in order to optimise the note delivered by the detection part. For example, algorithms called “genetic” or “revolutionary” algorithms can be used.

After dynamic beam conformation, the device comprises an objective (Fourier lenses (3), (4), for example) which focuses the beam thus structured and produces a spot at its focal point or thereabouts, having the desired spatial distribution. If the minimum dimension of this spot does not correspond to the desired dimensions, a lens and/or mirror imaging device (7) can be added downstream.

At the level of the image task, a sample (9) is placed on which the laser process is carried out. For example, the sample (9) is mechanically connected to a mobile assembly (10) controlled by computer. For example, this mobile assembly may be a motorized translation assembly optionally coupled with motorized rotation devices.

An assembly of the scanner type (8) (system with galvanometric mirrors) may also be inserted on the optical path before the formation of the image task in order to deviate the beam by computer control.

The advantages clearly appear from the description, and in particular, the significant decrease in costs by eliminating the wavefront sensor and using a simple detector suitable for supplying a negative feedback signal in conjunction with an algorithm selected to establish an error test convergence procedure with improvement during each error test.

1. Femtosecond laser micromachining device with dynamic beam conformation comprising:
a laser source emitting ultrashort pulses of a beam of coherent light radiation;
a dynamic beam conformation assembly;
a laser ray application and processing assembly,
wherein the dynamic beam conformation assembly comprises an optical system including an active part for modifying a wavefront of the beam and detection means, to the exclusion of a phase meter unit, for spatially formatting the beam, the active part and the detection means being connected by a negative feedback loop, the active part comprising a first fixed or active component and a second active component.

2. Device according to claim 1, wherein the means for spatially formatting the beam comprises a CDD camera or a photodetector.

3. Device according to claim 1, wherein the negative feedback loop applies an algorithm to adapt phase functions obtained by the first component and the second components, in order to optimise result in the form of a note attributed by criteria depending on a selected simple detection system.

4. Device according to claim 1, wherein the first component has a low spatial resolution in terms of wavefront.

5. Device according to claim 4, wherein when the first component is fixed, the first component comprises an afocal optical system which can be misadjusted in order to produce a wavefront curvature.

6. Device according to claim 4, wherein when the first component is fixed, the first component comprises a diffracting optical element for providing a preformatted function modulated by the second component.

7. Device according to claim 4, wherein when the first component is active, the first component comprises a system for obtaining a spatial phase modulation with a high dynamic and a low spatial resolution.

8. Device according to claim 1, wherein the second component has a high spatial resolution.

9. Device according to claim 8, wherein the second component is based on a liquid crystal layer and functions by reflection or by transmission for enhancing the spatial formatting of the wavefront.
